(19) United States
(12) Patent Application Publication
(10) Pub. No.: US 2010/0042861 A1
(43) Pub. Date: Feb. 18, 2010

(54) HOST, USB PORT MODULE, AND POWER MANAGEMENT METHOD THEREOF

(75) Inventor: Yong-Der Lee, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER, INC., Taipei (TW)

(21) Appl. No.: 12/506,243

(22) Filed: Jul. 20, 2009

(30) Foreign Application Priority Data
Aug. 14, 2008 (TW) 97130983

(51) Int. Cl. G06F 1/26

(52) U.S. Cl. 713/340; 257/213

(57) ABSTRACT

A universal serial bus (USB) port module for connecting an electronic apparatus with a USB is provided. The USB port module includes a USB controller and a detection circuit. The USB controller is coupled to the USB. The detection circuit is coupled to at least one of a first data line and a second data line in the USB and outputs a voltage thereon. The USB controller is disabled when the first data line and the second data line are both at a low voltage level. The USB controller is enabled when at least one of the first data line and the second data line is at a high voltage level.

### CROSS-REFERENCE TO RELATED APPLICATION

This application claims the priority benefit of Taiwan application serial no. 97130983, filed Aug. 14, 2008. The entirety of the above-mentioned patent application is hereby incorporated by reference herein and made a part of specification.

### BACKGROUND OF THE INVENTION

1. Field of the Invention

The present invention generally relates to a power management technique, and more particularly, to a power management technique for a universal serial bus (USB).

2. Description of Related Art

Previously, different peripheral devices have to be connected to a computer through different connection interfaces. For example, a modem and a mouse are connected through serial ports, and a printer is connected through a parallel port, etc. As a result, it is very difficult to manage all these input/output interfaces of different specifications. Besides, a computer has to be turned off before a peripheral device can be connected to or disconnected from the computer, which is also very inconvenient.

Thereby, a universal serial bus (USB) standard which supports a plug and play (PNP) function is established. Accordingly, a computer can be connected to different peripheral devices through a USB without having to be turned off or restarted. Presently, many electronic apparatuses are disposed with USB interfaces, such as keyboards, scanners, flash drives, and digital cameras, etc.

Along with the advancement of the techniques and changes in the requirements, the previously established USB standards (for example, USB 1.0 and USB 1.1) cannot meet the current requirements anymore. As a result, the USB 2.0 standard is established. The standard of USB 2.0 host controller can be referred to “Enhanced Host Controller Interface Specification for Universal Serial Bus” version 1.0 published by the Intel Corporation on Mar. 12, 2002 and the detail thereof will not be described herein.

It is well known that a standard USB connector has four pins, which are respectively a power pin, a ground pin, and a pair of data transmission pins, wherein USB signals are transmitted on a twisted pair data cable and half-duplex differential signaling is used to combat the effects of electromagnetic noise on longer cables.

Additionally, since USB can also carry power, when some simple electronic apparatuses are connected to a host through a USB, no additional power supply is required and these electronic apparatuses can operate directly on the power carried by the USB. However, a conventional USB module constantly receives an operating power regardless of whether any electronic apparatus is connected to the USB module. In other words, the operating power is supplied to the USB module even if no electronic apparatus is connected to the USB module. As a result, the power is consumed unnecessarily.

### SUMMARY OF THE INVENTION

Accordingly, the present invention is directed to a universal serial bus (USB) port module, wherein the USB port module can operate in a power-saving mode so that the power consumption thereof can be reduced.

The present invention is directed to a host using foregoing USB port module, wherein the power consumption of the host is reduced when no external electronic apparatus is connected to the USB port module.

The present invention is further directed to a power management method, wherein the power consumption of a USB is managed in different states to reduce the power consumption.

The present invention provides a USB port module for connecting an electronic apparatus with a USB. The USB port module includes a USB controller and a detection circuit. The USB controller is coupled to the USB. The detection circuit is coupled to at least one of a first data line and a second data line in the USB and outputs a voltage thereon. The USB controller is disabled when the voltages on both the first data line and the second data line are at a low level. The USB controller is enabled when the voltage on at least one of the first data line and the second data line is at a high level.

The present invention provides a host including a microprocessor unit, a USB, a USB controller, and a detection circuit. The USB is coupled to the USB controller and has a first data line and a second data line. The detection circuit is coupled to the microprocessor unit, the first data line, and the second data line and outputs a voltage on at least one of the first data line and the second data line to the microprocessor unit. The microprocessor unit disables the USB controller when it determines that the voltages on the first data line and the second data line are both at a low level. Contrarily, the microprocessor unit enables the USB controller when it determines that the voltage on at least one of the first data line and the second data line is at a high level.

In addition, the microprocessor unit further determines whether data is transmitted on the first data line and the second data line when the voltages on the first data line and the second data line are both at the high level. When data is transmitted on the first data line and the second data line, the microprocessor unit disables the detection circuit; and when data is not transmitted on the first data line and the second data line, the microprocessor unit enables the detection circuit.

According to an embodiment of the present invention, the detection circuit includes a first switch transistor and a second switch transistor. The gates of the first switch transistor and the second switch transistor both receive a switch signal, and the drains thereof are both coupled to the microprocessor unit. In addition, the sources of the first switch transistor and the second switch transistor are respectively coupled to the first data line and the second data line.

The present invention further provides a power management method for a USB. In the power management method, a detection module is provided for detecting the voltages on a first data line and a second data line in the USB. An operating power is supplied to the USB when the voltage on at least one of the first data line and the second data line is at a high level. Contrarily, the operating power is not supplied to the USB when the voltage on at least one of the first data line and the second data line is at a low level. As a result, the power consumption of the USB is reduced.

According to the present invention, an operating power is not supplied to a USB when the voltage on at least one of a first data line and a second data line is at a low level. Thereby, the power consumption of the USB is reduced.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a system block diagram of a universal serial bus (USB) port module according to an embodiment of the present invention.

FIG. 2 is a block diagram of a detection circuit according to an embodiment of the present invention.

FIG. 3 is a signal timing diagram of a USB port module according to an embodiment of the present invention.

FIG. 4 is a flowchart of a power management method for a USB according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

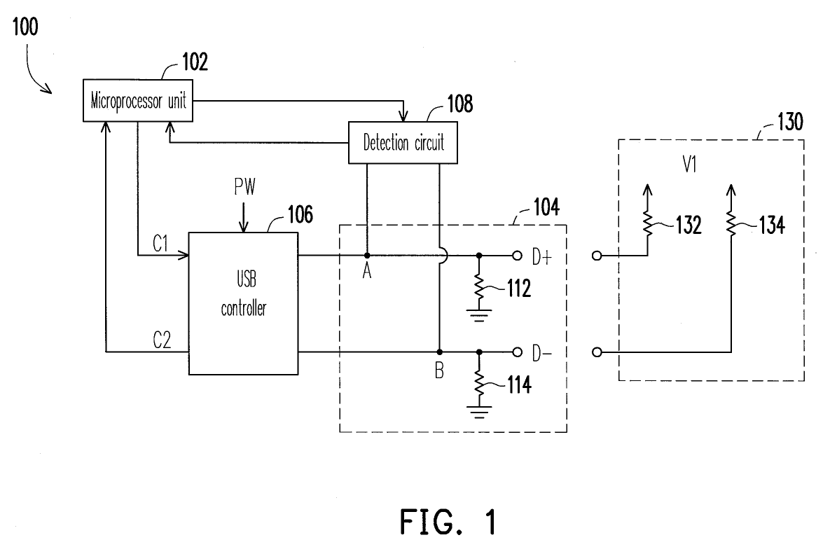

FIG. 1 is a system block diagram of a universal serial bus (USB) port module according to an embodiment of the present invention. Referring to FIG. 1, the USB port module 100 in the present embodiment is suitable for a host, such as a personal computer, a portable computer, a cell phone or PDA. The USB port module 100 includes a microprocessor unit 102, a USB 104, a USB controller 106, and a detection circuit 108. The microprocessor unit 102 is respectively coupled to the USB controller 106 and the detection circuit 108, and the USB controller 106 and the detection circuit 108 are respectively coupled to the USB 104.

The USB 104 is suitable for connecting an external electronic apparatus 130 with a USB interface, and the USB 104 has a first data line D+ and a second data line D−. In the present embodiment, the first data line D+ and the second data line D− are respectively coupled to the detection circuit 108 through a node A and a node B. Accordingly, the detection circuit 108 can detect the voltage on at least one of the first data line D+ and the second data line D− (i.e., voltages on the nodes A and B). Generally speaking, data transmitted on the data lines D+ and D− are corresponding differential signals. Besides, the data lines D+ and D− are both grounded through resistors 112 and 114. Thus, the voltages on the nodes A and B are at a low level before the electronic apparatus 130 is connected to the USB 104.

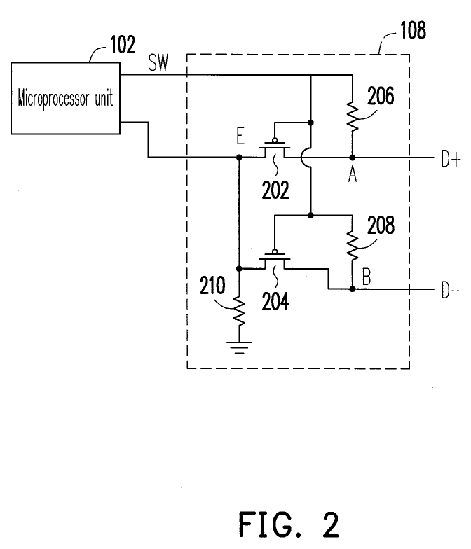

FIG. 2 is a block diagram of a detection circuit according to an embodiment of the present invention. Referring to FIG. 2, the detection circuit 108 includes a first switch transistor 202 and a second switch transistor 204. In the present embodiment, the first switch transistor 202 and the second switch transistor 204 are respectively implemented with a PMOS transistor. The gate of the first switch transistor 202 is coupled to the microprocessor unit 102 and to the first data line D+ and the source of the first switch transistor 202 through a resistor 206. In addition, the drain of the first switch transistor 202 is also coupled to the microprocessor unit 102.

Similarly, the gate of the second switch transistor 204 is coupled to the second data line D− and the source of the second switch transistor 204 through a resistor 208, and the gate of the second switch transistor 204 is coupled to the gate of the first switch transistor 202. In addition, the drain of the second switch transistor 204 is also coupled to the microprocessor unit 102. In the present embodiment, the drains of the switch transistors 202 and 204 are further grounded through a resistor 210.

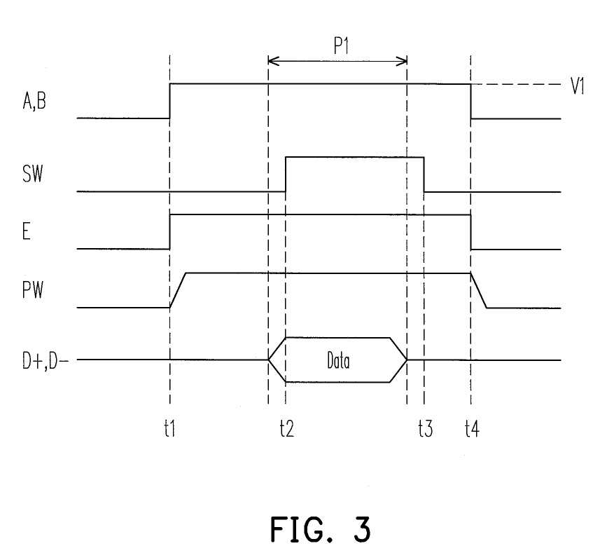

FIG. 3 is a signal timing diagram of a USB port module according to an embodiment of the present invention. Referring to FIGS. 1, 2, and 3, before the electronic apparatus 130 is connected to the USB port module 100, the voltages on the nodes A and B are maintained at a low level because the pull-down resistors 112 and 114 are grounded. Accordingly, the switch transistors 202 and 204 are both turned on so that the voltage on the node E is also maintained at the low level. When the microprocessor unit 102 determines that the voltage on the node E is at the low level, the microprocessor unit 102 sends a control signal C1 to the USB controller 106 to allow the USB controller 106 to enter a power-saving mode and stops supplying an operating power PW to the USB controller 106.

Assuming that the electronic apparatus 130 is connected to the USB port module 100 at a time point t1, then, the voltages on the nodes A and B are pulled up to a high voltage level V1 because the pull-up resistors 132 and 134 in the electronic apparatus 130 are connected to a voltage source V1. Similarly, the voltage on the node E is also pulled up to the high voltage level. When the microprocessor unit 102 determines that the voltage on the node E is pulled up to the high level, the microprocessor unit 102 sends the control signal C1 to the USB controller 106 to wake it up and starts to supply the operating power PW to the USB controller 106.

Additionally, assuming that data is transmitted on the data lines D+ and D− during the period P1, then, the USB controller 106 sends a control signal C2 to notify the microprocessor unit 102. The voltages of the data signals transmitted on the data lines D+ and D− are switched between high and low levels for indicating the data “1” or “0”. Thus, when the data is transmitted on the data lines D+ and D−, misoperations of the switch transistors 202 and 204 may be caused and accordingly the quality of transmitted data may be reduced. Such a situation is also referred to as “loading effect”.

In order to avoid the aforementioned loading effect, the microprocessor unit 102 pulls a switch signal SW up to a high level at a time point t2 when the microprocessor unit 102 determines that data is transmitted on the data lines D+ and D−. Then the switch transistors 202 and 204 are both disabled. In other words, the detection circuit 108 is disabled. The microprocessor unit 102 switches the switch signal SW back to the low level and enables the switch transistors 202 and 204 again when the data lines D+ and D− finish transmitting the data (at the time point t3).

Assuming that the electronic apparatus 130 is disconnected from the USB port module 100 at the time point t4, the voltages on the nodes A and B then return to the low level, and accordingly the voltage on the node E also returns to the low level. When the microprocessor unit 102 determines that the voltage on the node E is at the low level, the microprocessor unit 102 controls the USB controller 106 to enter the power-saving mode and stops supplying the operating power PW to the USB controller 106. As described above, in the present embodiment, unnecessary power consumption when the USB port module 100 is idle is avoided.

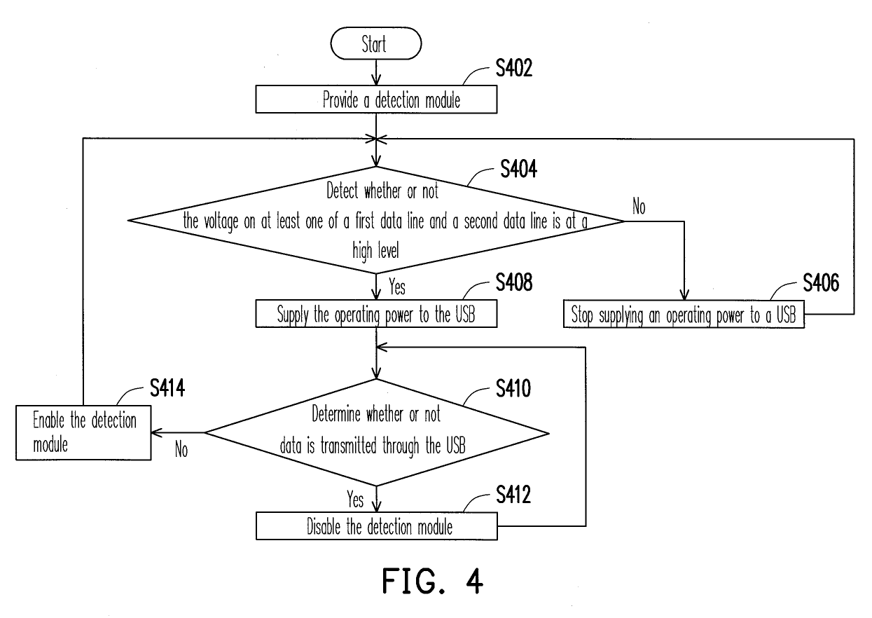

The present invention further provides a USB power management method. FIG. 4 is a flowchart of the USB power management method according to an embodiment of the present invention. Referring to FIG. 4, first, in step S402, a detection module is provided. Then, in step S404, the detection module detects whether the voltage on at least one of a first data line and a second data line in the USB is at a high level. If the detection module detects that the voltages on the first data line and the second data line are both at a low level (i.e., “no” in step S404), step S406 is executed to stop supplying an operating power to the USB.

Contrarily, if the detection module detects that the voltage on at least one of the first data line and the second data line is at a high level (i.e., “yes” in step S404), in step S408, the operating power is supplied to the USB to allow the USB to operate normally. After that, in step S410, whether the USB is transmitting data is determined. If it is determined in step S410 that there is data transmitted on the USB (i.e., “yes” in step S410), the detection module is disabled in step S412, and step S410 is repeated to determine whether the USB finishes transmitting the data.

If the data on the USB has all been transmitted or it is determined that there is no data transmitted on the USB in step S410 (i.e., “no” in step S410), in step S414, the detection module is enabled again or constantly enabled and foregoing process is repeated.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A universal serial bus (USB) port module, suitable for connecting an electronic apparatus with a USB, the USB port module comprising:
a USB controller, coupled to the USB; and
a detection circuit, coupled to at least one of a first data line and a second data line in the USB, for outputting a voltage on at least one of the first data line and the second data line,
wherein the USB controller is disabled when the voltage on at least one of the first data line and the second data line is at a low level, and
the USB controller is enabled when the voltage on at least one of the first data line and the second data line is at a high level.

2. The USB port module according to claim 1, wherein the detection circuit comprises:
a first switch transistor, having a gate for receiving a switch signal, a source coupled to the first data line, and a drain for outputting the voltage on the first data line; and
a second switch transistor, having a gate for receiving the switch signal, a source coupled to the second data line, and a drain for outputting the voltage on the second data line.

3. The USB port module according to claim 1, wherein the first switch transistor and the second switch transistor are PMOS transistors.

4. A host, comprising:
a microprocessor unit;
a USB, having a first data line and a second data line;
a USB controller, coupled to the USB and the microprocessor unit; and
a detection circuit, coupled to the microprocessor unit, the first data line, and the second data line, for outputting a voltage on at least one of the first data line and the second data line to the microprocessor unit,
wherein the microprocessor unit disables the USB controller when the microprocessor unit determines that the voltage on at least one of the first data line and the second data line is at a low level, and
the microprocessor unit enables the USB controller when the microprocessor unit determines that the voltage on at least one of first data line and the second data line is at a high level.

5. The host according to claim 4, wherein the microprocessor unit further determines whether data is transmitted on the first data line and the second data line when the voltages on the first data line and the second data line are both at the high level,
the microprocessor unit disables the detection circuit when data is transmitted on the first data line and the second data line, and
the microprocessor unit enables the detection circuit when data is not transmitted on the first data line and the second data line.

6. The host according to claim 4, wherein the detection circuit comprises:
a first switch transistor, having a gate for receiving a switch signal, a source coupled to the first data line, and a drain coupled to the microprocessor unit; and
a second switch transistor, having a gate for receiving the switch signal, a source coupled to the second data line, and a drain coupled to the microprocessor unit.

7. The host according to claim 4, wherein the first switch transistor and the second switch transistor are PMOS transistors.

8. A power management method for a USB, comprising:
providing a detection module for detecting voltages on a first data line and a second data line in the USB;
supplying an operating power to the USB when the voltage on at least one of the first data line and the second data line is at a high level; and
stopping supplying the operating power to the USB when the voltage on at least one of the first data line and the second data line is at a low level.

9. The power management method according to claim 8 further comprising:
determining whether or not data is transmitted through the USB when the operating power is supplied to the USB; and
disabling the detection module when data is transmitted through the USB.

10. The power management method according to claim 9, wherein the detection module is enabled when the USB finishes transmitting the data.
